(19) United States
(12) Patent Application Publication
(10) Pub. No.: US 2020/0187311 A1
(43) Pub. Date: Jun. 11, 2020

(54) INDUCTION HEATING DEVICE AND SYSTEM

(71) Applicant: MASKINTEKNIK I OSKARSHAMN AB, Oskarshamn (JP)

(72) Inventors: Juha PEHKONEN, Oskarshamn (SE); Jonathan SHARP, Oskarshamn (SE); Linda SHARP, Oskarshamn (SE)

(21) Appl. No.: 16/630,769

(22) PCT Filed: Jul. 10, 2018
(86) PCT No.: PCT/SE2018/050757

§ 371 Date: Jan. 13, 2020

(30) Foreign Application Priority Data
Jul. 14, 2017 (SE) 1750926-6

(51) Int. Cl. H05B 6/10; H05B 6/36; H05B 6/14

(52) U.S. Cl. CPC H05B 6/109; H05B 6/14; H05B 6/36

(57) ABSTRACT

An induction heating device (1) comprising an electromagnetic coil (2) connectable to a power supply (3). The electromagnetic coil (2) comprises a coil protection insert (4). The coil protection insert (4) protrudes from a first side (5) of the coil (2) towards a surface (6) of a work piece (7) to be heated by the induction heating device (1) when the induction heating device (1) is used for heating the work piece (7). The coil protection insert (4) preventing contact between the coil (2) and the surface (6) of the work piece (7).

### TECHNICAL FIELD

The present invention relates to an induction heating device and system.

### BACKGROUND

Induction heaters are used for heating metal materials by induction. The process is used in maintenance, hardening processes and heating processes to form, shrink or expand materials.

Induction heating is used when there is a need for a concentrated heating process, since induction heating doesn't spread heat far outside the treatment area.

There are several types of induction heating systems. There are both stationary and handheld heating tools. In particular when using handheld induction heating tools, it is easy to accidently create physical contact between parts of the heating coil and the material to be heated. The physical contact can create a short circuit through the material, resulting in sparking or localised over-heating, which can potentially damage the material by pittings and burn marks. These pittings and burn marks are especially harmful when the surface to be treated has to have a non-damaged/affected finish.

The effectiveness of the induction heating process depends on the distance between the coil and the material to be heated. The recommended distance by probe manufactures is between as close as possible without contact up to a few millimetres.

Generally in induction heating, holding/maintaining the device at a shorter distance results in a more effective heating process, but also increases the risk for sparks and short-circuiting. The strong magnetic forces that occur between the coil and the material to be heated also make it difficult to keep the recommended distance. If the distance between the coil and the material to be heated is fluctuating, it may cause an un-even heating process.

Heat-resistant coating over the coil is sometimes used to avoid the above stated problem, but these easily and quickly wear off.

The current practice is to avoid using handheld induction heating tools when heating sensitive and/or expensive material surfaces. Handheld induction heaters are currently only used for heating rough surfaces.

When handheld induction heaters are used on high quality surfaces, the surfaces need to be re-finished through machining (grinding, polishing etc.) if damaged. The method of using handheld induction heaters is therefore limited to heating rough surfaces where the surface look or finish is not important.

Uneven heating, due to that the distance between the handheld induction heater and the treated surface has varied, can also affect the material strength of the treated material, i.e. creating weak points in the material.

If/when the device touches the material to be heated the life expectancy of the device will be shortened.

Keeping the device at the recommended distance is difficult and tiresome. Skill and experience of the person using the device is required in order to limit the risk for damaging the material.

It therefore exists a need for an induction heating device and system by which the user or the machinery which holds and steers the device does not accidently create physical contact between the electromagnetic coil and the material to be heated. Such a physical contact can otherwise create a short circuit through the heated material, resulting in sparking or localised over-heating, which subsequently can potentially damage the material by pittings and burn marks. In addition to this such a physical contact can also shorten the life expectancy of the device itself. Furthermore, it is desirable to find a technical solution for keeping the induction heating device at a constant and minimum distance from the material to be treated, so that the device is heating the material to be heated in a maximum and optimal manner. It is also desirable to invent a solution for permitting the induction heating device to be easily moved over the area to be treated. Finally, it would be advantageous to find a solution which has good durability in the harsh work environment which the induction heating device is exposed.

### SUMMARY OF INVENTION

An objective of the present invention is thus to accomplish an induction heating device and system by which the user or the machinery which holds and steers the device does not accidently create physical contact between the electromagnetic coil and the material to be heated. Such a physical contact can otherwise result in sparking or localised over-heating, which subsequently can potentially damage the material by pittings and burn marks. In addition to this such a physical contact can also shorten the life expectancy of the device itself. Furthermore, one objective is to find a technical solution for keeping the induction heating device at a constant and minimum distance from the material to be treated. Another objective is to invent a solution for permitting the induction heating device to be easily moved over the area to be treated. A final objective is to find a solution which has good durability in the harsh work environment which the induction heating device is exposed.

According to one aspect, the invention concerns an induction heating device comprising an electromagnetic coil connectable to a power supply. The electromagnetic coil comprises a coil protection insert. The coil protection insert protrudes from a first side of the coil towards a surface of a work piece to be heated by the induction heating device when the induction heating device is used for heating the work piece. The coil protection insert preventing contact between the coil and the surface of the work piece.

An advantage with the solution, is that by having the electromagnetic coil comprising a coil protection insert the user or the machinery which holds and steers the device does not accidently create physical contact between the electromagnetic coil and the material to be heated. This physical contact could otherwise result in sparking or localised over-heating, which subsequently could potentially damage the material by pittings and burn marks. In addition to this such a physical contact can also shorten the life expectancy of the device itself. Furthermore, the coil protection insert keeps the induction heating device at a constant distance and potentially also at a minimum distance from the material to be treated.

The above system may be configured according to different optional embodiments. For example, the coil protection insert may be arranged in a coil protection insert recess of the coil.

An advantage with the solution, by having a coil protection insert recess the coil protection insert may be easily placed within a specific position in/onto the coil. This may facilitate the production of the induction heating device. Furthermore the coil protection insert is partly protected by being inserted into a recess.

According to an embodiment of the invention, the coil protection insert may comprise a plurality of protrusions, each protrusion being arranged at the first side of the coil.

An advantage with the solution, by having a plurality of protrusions, is that it makes the solution much more flexible with regards to producing the device and for the device to suit any shape of work piece.

According to an embodiment of the invention, each of the plurality of protrusions is arranged in a respective coil protection insert recess of the coil.

An advantage with the solution, by having each of the plurality of protrusions arranged in a respective coil protection insert recess each of the plurality of protrusions may be easily placed within a specific position in/onto the coil. This may facilitate the production of the induction heating device. Furthermore each of the plurality of protrusions is partly protected by being inserted into a recess.

According to an embodiment of the invention, the plurality of protrusions may embrace substantially the whole first side of the coil.

An advantage with the solution, by having the plurality of protrusions embracing substantially the whole first side of the coil is that the whole first side of the coil which is facing the work piece is protected from the work piece. This implies that the user or the machinery which holds and steers the device does not accidently create physical contact between the electromagnetic coil and the material to be heated. This physical contact could otherwise result in sparking or localised over-heating, which subsequently could potentially damage the material by pittings and burn marks. Furthermore, the plurality of protrusions keep the induction heating device at a constant distance and potentially also at a minimum distance from the material to be treated.

According to an embodiment of the invention, the coil protection insert or the plurality of protrusions may be spherically shaped.

An advantage with the solution, is that a spherically shaped coil insert or a plurality of protrusions promotes gliding towards any material, i.e. a lower friction between the coil and the work piece is achieved when the induction heating device is in use.

According to an embodiment of the invention, the plurality of protrusions may be rollably connected to the coil (2).

An advantage with the solution, is that a plurality of rollably connected protrusions promotes rolling towards any material, i.e. a lower friction between the coil and the work piece is achieved when the induction heating device is in use.

According to an embodiment of the invention, the coil protection insert or the plurality of protrusions may be fixedly connected to the coil.

An advantage with the solution, is that a fixedly connected coil protection insert or a plurality of protrusions may be relatively cheap to manufacture and easy to install.

According to an embodiment of the invention, the coil protection insert or the plurality of protrusions may have a spherical, chamfered or rounded head.

An advantage with the solution, is that having a coil insert or a plurality of protrusions which has a spherical, chamfered or rounded head promotes gliding towards any material, i.e. a lower friction between the coil and the work piece is achieved when the induction heating device is in use.

According to an embodiment of the invention, the coil protection insert or the plurality of protrusions may be of a non-conductive, non-magnetic, heat and tear-and-wear resistant material.

An advantage with the solution, is that a non-conductive and non-magnetic material decreases the risks of sparking when the induction heating device is in use. An induction heating device could otherwise subsequently potentially damage the material/work piece by pittings and burn marks.

Another advantage with the solution, is that a heat and tear-and-wear resistant material improves the life expectancy of the coil inserts, which subsequently improves the life expectancy of the device.

According to an embodiment of the invention, the coil protection insert or the plurality of protrusions may be of a ceramic material.

An advantage with the solution, is that a ceramic material decreases the risks of sparking when the induction heating device is in use. An induction heating device could otherwise subsequently potentially damage the material/work piece by pittings and burn marks.

Another advantage with the solution, is that a ceramic material improves the life expectancy of the coil inserts/protrusions.

According to an embodiment of the invention, the plurality of protrusions may be of varying shapes and sizes that can match and pair depending on circumstance.

An advantage with the solution, by having a plurality of protrusions that are of varying shapes and sizes, is that they can match and pair depending on circumstance. This makes the solution much more flexible with regards for the device to suit any shape of work piece.

According to an embodiment of the invention, the induction heating device may comprise a magnetic field concentrator arranged at a second side of the coil, wherein the second side is opposite from the first side.

An advantage with the solution, is that the magnetic field concentrator enables the system to achieve increased efficiency of induction heating by better focusing the thermal field to the chosen areas subjected to heat treatment. Heating then occurs with higher precision in the area intended, and this subsequently results in electric energy savings. The principle of magnetic field concentrators consists in the orientation of the magnetic component of the electromagnetic field and in optimal configuration of the field lines, which results in a more effective and energy-saving production process.

According to an embodiment of the invention, the magnetic field concentrator may extend from the second side of the coil towards the first side of the coil so that the magnetic field concentrator at least partly encloses the coil.

An advantage with the solution, is that a magnetic field concentrator which at least partly encloses the coil extending towards the first side of the coil enables the system to achieve even more increased efficiency of induction heating by even better focusing the thermal field to the chosen areas subjected to heat treatment. Heating then occurs with even higher precision in the area intended, and this subsequently results in even higher electric energy savings.

According to a second aspect, the invention concerns an induction heating system comprising a power supply, an induction heating device and an electric cable for delivering electricity from the power supply to the induction heating device.

An advantage with the solution, is that it permits the system to heat the work piece by induction and to avoid contact between the coil and the surface of the work piece.

An induction heating system consists of an induction power supply for converting line power to an alternating current and delivering it to a work-head, and an electromagnetic coil for generating an electromagnetic field. With the help of an alternating electric field, energy is subsequently transmitted to a work piece to be treated by induction heat. The work piece is preferably positioned in close proximity to the coil such that the alternating electromagnetic field creates an eddy current in the work piece, which in turn produces heat.

Heat is only produced by the induced current transmitted through the work piece. However, heat could spread from the work piece to the coil. Therefore the coil could be water-cooled in order to keep down the temperature in the coil.

The material of the work piece to be treated can be of a metal material, such as copper, aluminium, steel, or brass. It can also be a semiconductor such as graphite, carbon or silicon carbide.

For heating non-conductive materials such as plastics or glass, induction can be used to heat an electrically-conductive susceptor e.g., graphite, which then passes the heat to the non-conducting material.

Induction heating finds applications in processes where temperatures are as low as 100° C. and as high as 3000° C. It is also used in short heating processes lasting for less than half a second and in heating processes that extend over several months.

Either the coil/induction heating device is moved by hand or by a machine and the work piece is fixed while the work piece is heated, or the work piece is moved by hand or by a machine and the coil/induction heating device is fixed while the work piece is heated.

Adding a magnetic field concentrator to the induction heating device provides certain advantages as mentioned above. However, the developed induction heating device works indeed also well without such a magnetic field concentrator.

The coil insert could for instance be pin-, ball-, rod- or plate-shaped among others.

The coil protection insert protects the work piece from physical contact with the electromagnetic coil. Such a physical contact can otherwise create a short circuit through the heated material, resulting in sparking or localised over-heating, which subsequently can potentially damage the work piece by pittings and burn marks.

The induction heating device could be produced in any type of shape in order to suit a specific work piece. Some examples of shapes are provided in the figures attached. The given examples of different type of shapes could for instance be combined together. Furthermore, one type of shape could be a three dimensional roller coaster/wave shape which would well suit a wave-shaped work piece.

The electromagnetic coil with embedded coil protection inserts can e.g. be mounted onto an induction machine that is stationary, onto a CNC driven machine, onto a robotic arm, or any other suitable control mechanism. Working with any combination above, the material to be heated can be set on a surface without mounting or mounted to a fixed surface, and subsequently fed through or into/onto the coil for heating by hand, by tools, by CNC driven machinery, or any other machine, robot, or other system able to feed material to/onto/into the induction coil.

The induction heating device may be connected to a handle permitting the induction heating device to be directly operated by a human being. An advantage with this solution, is that a human being can hold and steer the induction heating device via the handle which is connected to the device. The human being can by using the device heat a material and at the same time prevent to accidently create physical contact between the electromagnetic coil and the material to be heated. This physical contact could otherwise result in sparking or localised over-heating, which subsequently could potentially damage the material by pittings and burn marks. Furthermore, the coil protection insert keeps the induction heating device at a constant distance and potentially also at a minimum distance from the material to be treated which otherwise would be very difficult for the human being to achieve.

The induction heating device may be fixedly connected to a steering and control system permitting the induction heating device to be operated by the steering and control system. An advantage with this solution, is that a steering and control system can hold and steer the induction heating device. The steering and control system can by using the device heat a material and at the same time prevent to accidently create physical contact between the electromagnetic coil and the material to be heated. This physical contact could otherwise result in sparking or localised over-heating, which subsequently could potentially damage the material by pittings and burn marks. Furthermore, the coil protection insert keeps the induction heating device at a constant distance and potentially also at a minimum distance from the material to be treated which otherwise could prove difficult for the steering and control system to achieve.

To clarify what is meant by: that each of the plurality of protrusions is arranged in a respective coil protection insert recess of the coil—is that each protrusion is arranged in its own specific coil protection insert recess. This implies that there could be a plurality of coil protection insert recesses.

The coil protection insert or the plurality of protrusions could be arranged in a coil protection insert/plurality of protrusions holder, wherein the holder is fixedly arranged onto the coil. This to facilitate the installation of the coil protection insert or the plurality of protrusions to the induction heating device.

The electromagnetic coil may comprise a coil protection insert. Other induction devices prior to this invention may have isolated the coil from the work piece by adding coil protection components for instance to a coil housing or to an intermediate carrier comprising also the coil. These solutions are physically very static and would thus not be able take different shapes. They would therefore not meet the features of the here described invention which is physically adaptive enough for easily taking any possible shape compatible with the shape of any work piece possibly imagined. Examples of possible shapes of the invention are shown in FIG. 9-11. Further to this, a conductor/conducting material could initially comprise said protection inserts, and subsequently be formed as an electromagnetic coil. Thus, a conductor/conducting material could comprise said protection inserts, functioning as isolating means, even prior the electromagnetic coil is formed from the conductor/conducting material.

### BRIEF DESCRIPTION OF DRAWINGS

The invention is now described, by way of example, with reference to the accompanying drawings, in which:

FIG. 1 shows an induction heating device and an induction heating system in a perspective view, and

FIG. 2a shows an induction heating device in a front view; FIG. 2b shows an induction heating device in a side view; FIG. 2c shows an induction heating device in a top view; FIG. 2d shows an induction heating device in a perspective view, and

FIG. 3a shows an induction heating device with a handle in a top view; FIG. 3b shows an induction heating device with a handle in a perspective view, and

FIG. 4 shows an induction heating device with a handle in a perspective view together with a work piece, and

FIG. 5. shows an induction heating device with a handle in a perspective view together with a human being, and

FIG. 6 shows an induction heating device with a steering and control system in a perspective view together with a work piece, and

FIG. 7a shows an induction heating device in a front view; FIG. 7b shows an induction heating device in a side view; FIG. 7c shows an induction heating device in a top view; FIG. 7d shows an induction heating device in a perspective view, and

FIG. 8a-8i show an induction heating device in a front view with different types of coil protection inserts combined with different types of coil protection insert recesses, and

FIG. 9 shows an induction heating device in one type of format in a perspective view, and

FIG. 10 shows an induction heating device in one type of format in a perspective view, and

FIG. 11 shows an induction heating device in one type of format in a perspective view.

### DESCRIPTION OF EMBODIMENTS

In the following, a detailed description of an induction heating device and system, is provided.

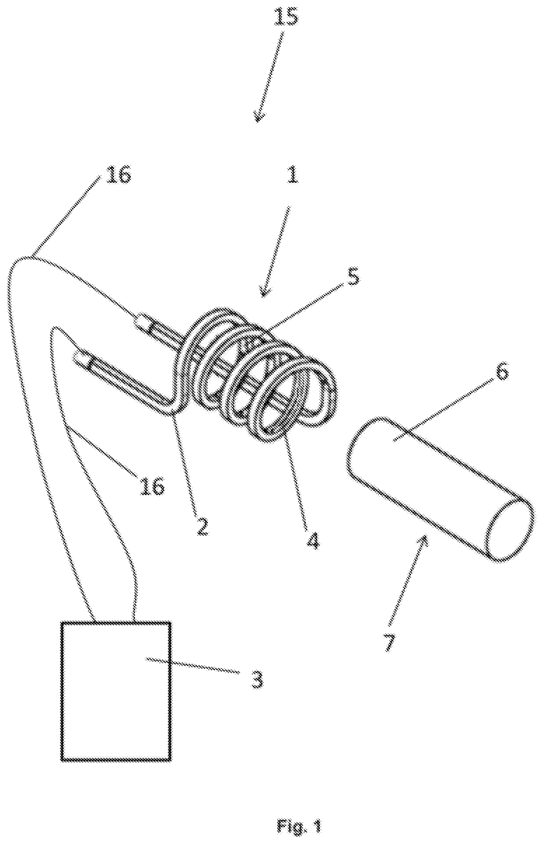

FIG. 1 shows an induction heating device 1 and system according to an embodiment of the invention, comprising an electromagnetic coil 2 connectable to a power supply 3 via an electric cable 16. The electromagnetic coil 2 comprising a coil protection insert 4. Wherein the coil protection insert 4 protrudes from a first side 5 of the coil 2 towards a surface 6 of a work piece 7 to be heated by the induction heating device 1 when the induction heating device 1 is used for heating the work piece 7. The coil protection insert 4 preventing contact between the coil 2 and the surface 6 of the work piece 7.

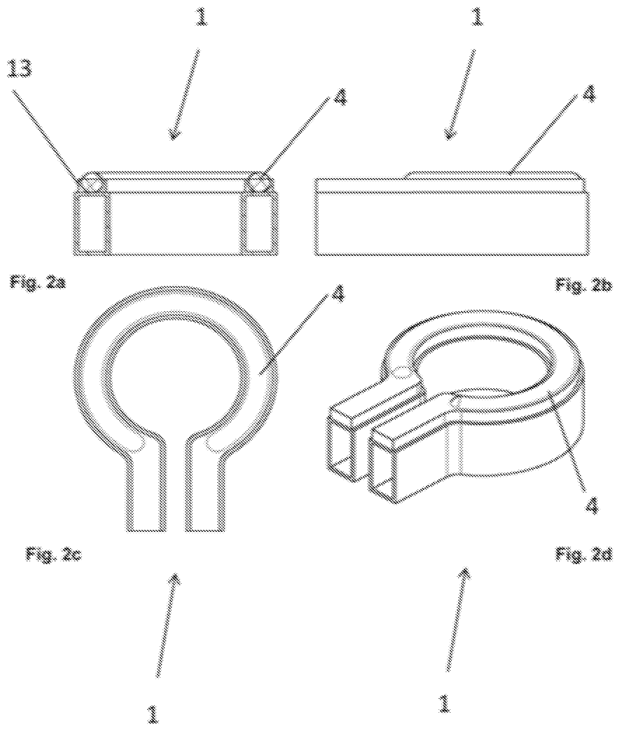

FIG. 2a-2d show an induction heating device 1 comprising a coil protection insert 4. Wherein the coil protection insert 4 in FIG. 2a is arranged in a coil protection insert recess 13 of the coil 2.

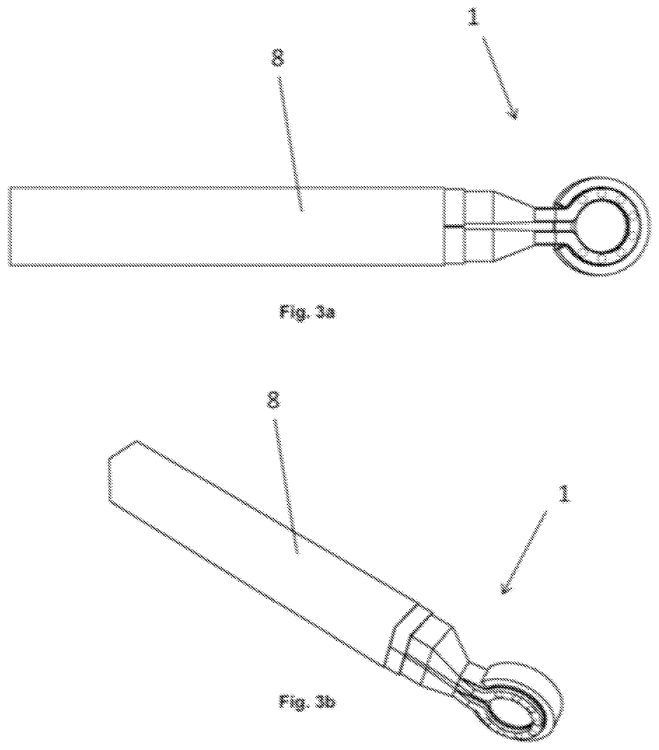

FIG. 3a-3b show an induction heating device 1 connected to a handle 8.

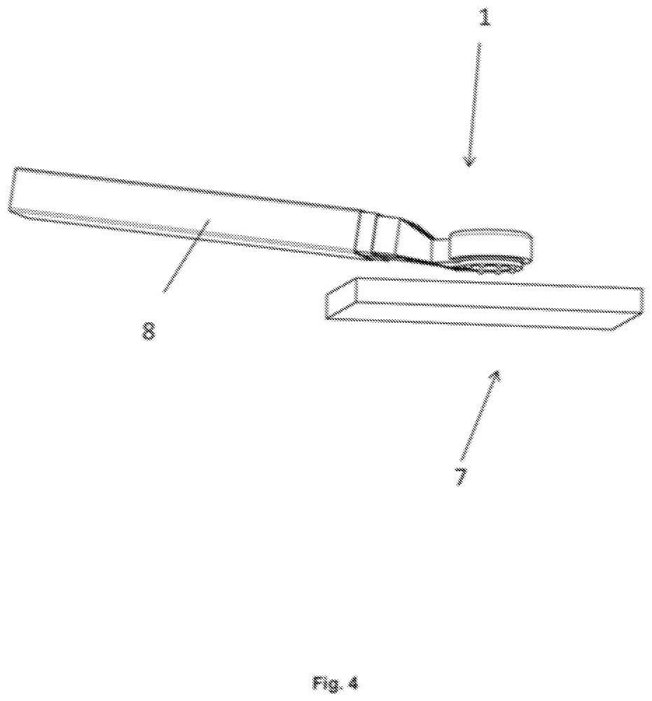

FIG. 4 shows an induction heating device 1 connected to a handle 8 together with a work piece 7.

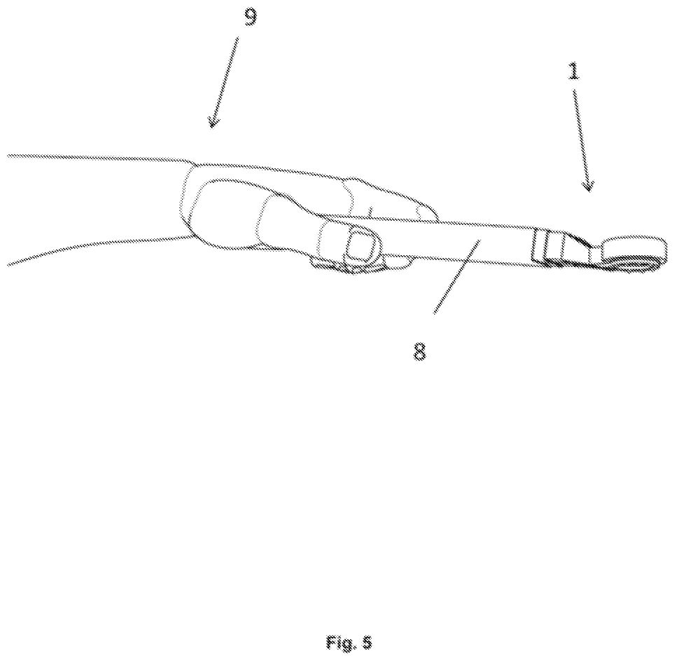

FIG. 5 shows an induction heating device 1 connected to a handle 8 steered by a human being 9.

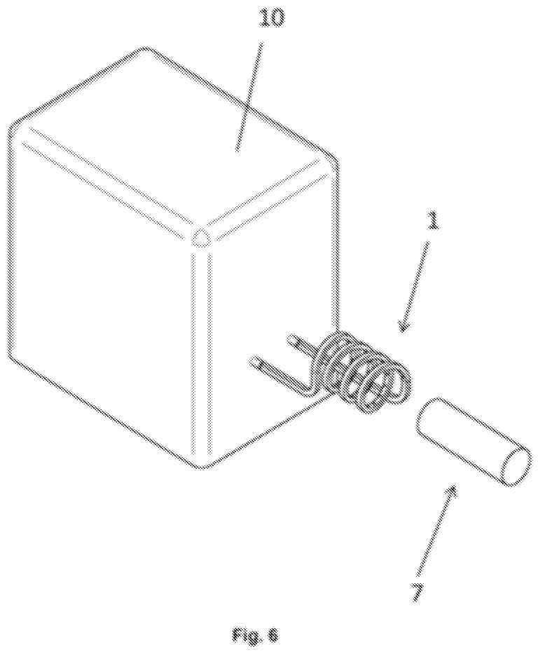

FIG. 6 shows an induction heating device 1 connected to a steering and control system 10 together with a work piece 7.

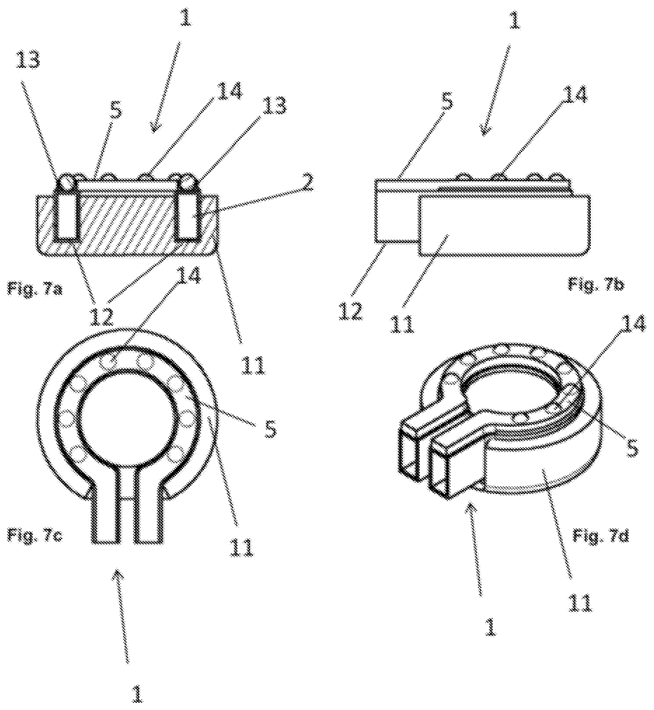

FIG. 7a-7d show an induction heating device 1. Wherein the coil protection insert 4 comprises a plurality of protrusions 14. Each protrusion 14 being arranged at the first side 5 of the coil 2. The induction heating device 1 comprising a magnetic field concentrator 11 arranged at a second side 12 of the coil 2. Wherein the second side 12 is opposite from the first side 5. Further, the magnetic field concentrator 11 extends from the second side 12 of the coil 2 towards the first side 5 of the coil 2 so that the magnetic field concentrator 11 at least partly encloses the coil 2. The plurality of protrusions 14 embraces substantially the whole first side 5 of the coil 2. Wherein each of the plurality of protrusions 14 in FIG. 7a being arranged in a respective coil protection insert recess 13 of the coil 2.

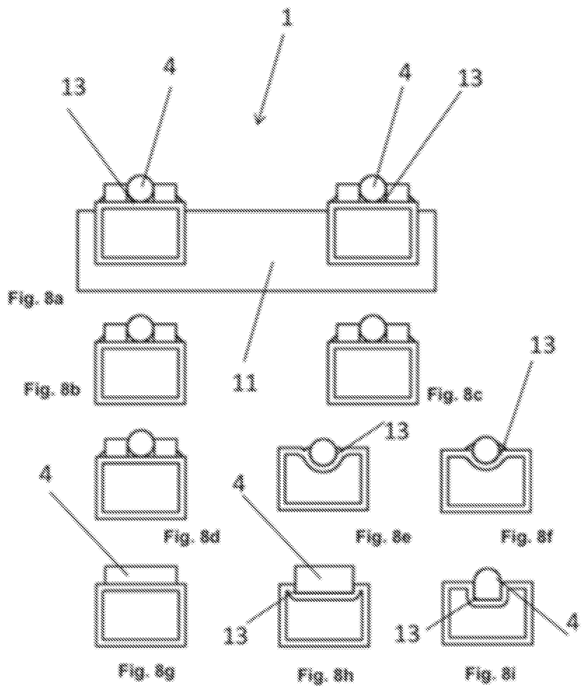

FIG. 8a-8i show an induction heating device 1 with different types of coil protection inserts 4 combined with different types of coil protection insert recesses 13. Wherein in FIG. 8a-8f the coil protection insert or the plurality of protrusions 14 is spherically shaped. Wherein in FIG. 8i the coil protection insert has a spherical, chamfered or rounded head.

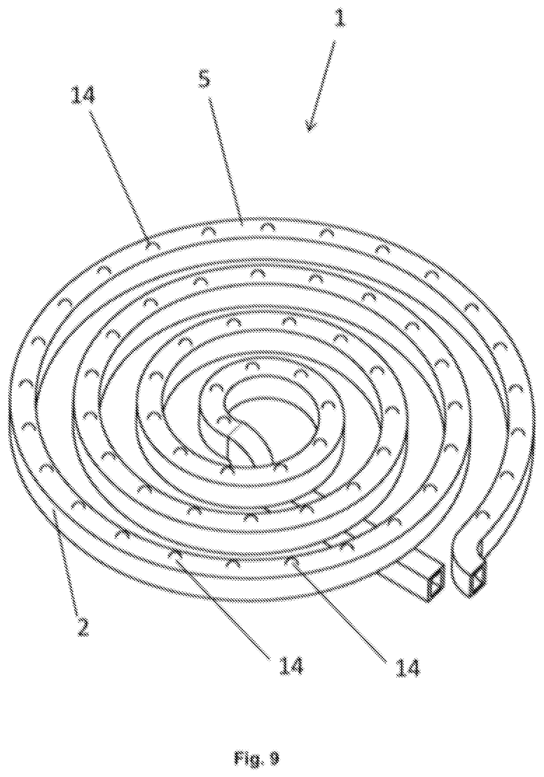

FIG. 9 shows an induction heating device 1. Wherein the coil 2 comprises a plurality of protrusions 14. Each protrusion 14 being arranged at the first side 5 of the coil 2.

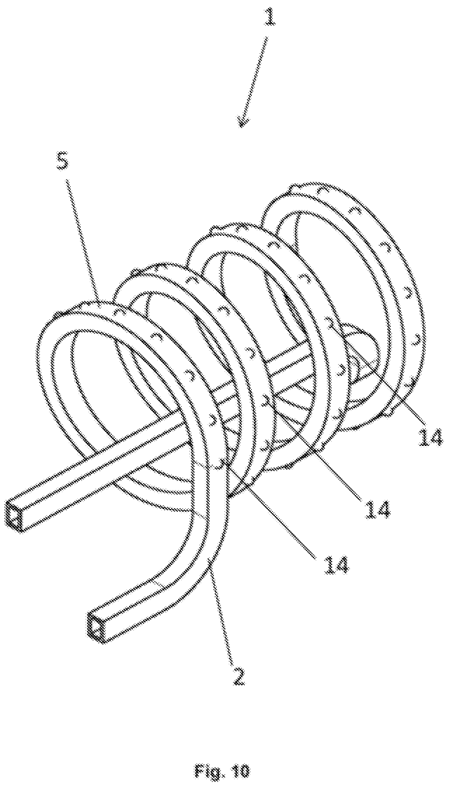

FIG. 10 shows an induction heating device 1. Wherein the coil 2 comprises a plurality of protrusions 14. Each protrusion 14 being arranged at the first side 5 of the coil 2.

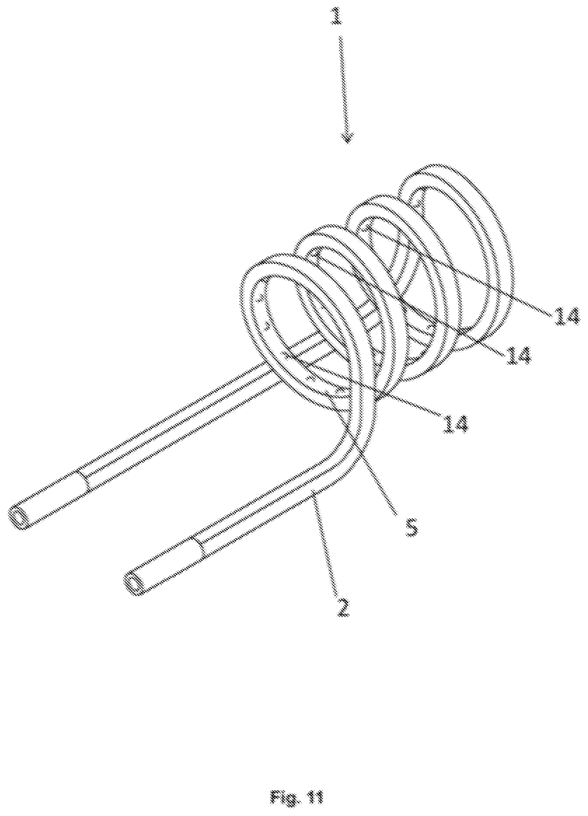

FIG. 11 shows an induction heating device 1. Wherein the coil 2 comprises a plurality of protrusions 14. Each protrusion 14 being arranged at the first side 5 of the coil 2.

1. An induction heating device (1) comprising an electromagnetic coil (2) connectable to a power supply (3), characterised in that the electromagnetic coil (2) comprises a coil protection insert (4), wherein the coil protection insert (4) protrudes from a first side (5) of the coil (2) towards a surface (6) of a work piece (7) to be heated by the induction heating device (1) when the induction heating device (1) is used for heating the work piece (7), the coil protection insert (4) preventing contact between the coil (2) and the surface (6) of the work piece (7).

2. An induction heating device (1) according to claim 1, wherein the coil protection insert (4) is arranged in a coil protection insert recess (13) of the coil (2).

3. An induction heating device (1) according to any of the claim 1 or 2, wherein the coil protection insert (4) comprises a plurality of protrusions (14), each protrusion (14) being arranged at the first side (5) of the coil (2).

4. An induction heating device (1) according to claim 3, wherein each of the plurality of protrusions (14) is arranged in a respective coil protection insert recess (13) of the coil (2).

5. An induction heating device (1) according to claim 3 or 4, wherein the plurality of protrusions (14) embraces substantially the whole first side (5) of the coil (2).

6. An induction heating device (1) according to any of the claims 1-5, wherein the coil protection insert (4) or the plurality of protrusions (14) is spherically shaped.

7. An induction heating device (1) according to claim 6, wherein the plurality of protrusions (14) is rollably connected to the coil (2).

8. An induction heating device (1) according to any of the claims 1-6, wherein the coil protection insert (4) or the plurality of protrusions (14) is fixedly connected to the coil (2).

9. An induction heating device (1) according to any of the claim 1-5 or 8, wherein the coil protection insert (4) or the plurality of protrusions (14) has a spherical, chamfered or rounded head.

10. An induction heating device (1) according to any of the claims 1-9, wherein the coil protection insert (4) or the plurality of protrusions (14) is of a non-conductive, non-magnetic, heat and tear-and-wear resistant material.

11. An induction heating device (1) according to any of the claims 1-10, wherein the coil protection insert (4) or the plurality of protrusions (14) is of a ceramic material.

12. An induction heating device (1) according to claim 3-11, wherein the plurality of protrusions (14) are of varying shapes and sizes that can match and pair depending on circumstance.

13. An induction heating device (1) according to any of the claims 1-12, the induction heating device (1) comprising a magnetic field concentrator (11) arranged at a second side (12) of the coil (2), wherein the second side (12) is opposite from the first side (5).

14. An induction heating device (1) according to claim 13, wherein the magnetic field concentrator (11) extends from the second side (12) of the coil (2) towards the first side (5) of the coil (2) so that the magnetic field concentrator (11) at least partly encloses the coil (2).

15. An induction heating system (15) comprising a power supply (3) and an induction heating device (1) according to any of the claims 1-14, and an electric cable (16) for delivering electricity from the power supply (3) to the induction heating device (1), permitting the system (15) to heat the work piece (7) by induction and to avoid contact between the coil (2) and the surface (6) of the work piece (7).
